(19) United States
(12) Patent Application Publication
(10) Pub. No.: US 2021/0334505 A1
(43) Pub. Date: Oct. 28, 2021

(54) IMAGE CAPTURING SYSTEM AND METHOD FOR CAPTURING IMAGE

(71) Applicant: AuthenX Inc., Hsinchu County (TW)

(72) Inventors: Sheng-Fu LIN, Hsinchu County (TW); Chiu-Lin YU, Hsinchu County (TW); Kai-Lun HAN, Hsinchu County (TW); Po-Kuan SHEN, Hsinchu County (TW); Chun-Chiang YEN, Hsinchu County (TW); Yu-Chun WANG, Hsinchu County (TW); Jenq-Yang CHANG, Hsinchu County (TW); Mao-Jen WU, Hsinchu County (TW)

(21) Appl. No.: 17/369,991

(22) Filed: Jul. 8, 2021

Related U.S. Application Data
(63) Continuation-in-part of application No. 17/133,703, filed on Dec. 24, 2020.
(60) Provisional application No. 62/959,128, filed on Jan. 9, 2020.

(51) Int. Cl. G06K 9/00; G06K 9/20; H04N 5/225

(52) U.S. Cl. CPC G06K 9/0012; G06K 9/00114; H04N 5/2256; G06K 9/2036; G06K 9/209

(57) ABSTRACT

An image capturing system is disclosed. The image capturing system includes a mainboard, a laser device, an image sensing device, and a data processing device. The laser device is electrically connected to the mainboard, and the laser device includes a laser source. The laser source is configured to emit a laser light. The image sensing device is electrically connected to the mainboard, and the image detecting device includes an aperture and an image sensor. The reflected or scattered light of the laser light passes through the aperture to form an image. The image sensor is configured to generate an image signal according to the image. The data processing device is electrically connected to the mainboard, and the data processing device is configured to generate a liveness detection signal according to the image signal.

### RELATED APPLICATIONS

The present application is a continuation-in-part application of U.S. application Ser. No. 17/133,703, filed Dec. 24, 2020, and claims priority to U.S. Application Ser. No. 62/959,128, filed Jan. 9, 2020, which is herein incorporated by reference.

### BACKGROUND

### Field of Invention

The present disclosure relates to an image capturing device and a method for processing image. More particularly, the present disclosure relates to an image capturing device for detecting liveness and processing relative signals according to images which are captured at short range, so as to recognize living body, such that the present disclosure can be used in fingerprint recognition and biometrics.

### Description of Related Art

With the development of the technology, various electronic products and payment mechanism occur one after another, so as to meet usage habits and demands of customers. Therefore, customers pay more and more attentions to personal profile. For the past few years, how to enhance security of electronic products becomes an important task for the industry.

For enhancing security of electronic products and electronic payment, biometric technology becomes more and more important. Advantage of biometric technology is that it uses special biometrics among people to perform identification, so as to increase security substantially.

However, lawbreakers manufacture props which have biometrics in order to enter electronic products. For example, if the electronic product adopts fingerprint to perform identification, lawbreakers use molds or applicable materials to manufacture fake props with the fingerprint of the customer, so as to pass the identification. As a result, even biometric technology is adopted, there are still doubts about being deciphered by lawbreakers. Therefore, how to determine whether the fingerprint is from a living body or from a non-living body is extremely important during fingerprint identification. For enhancing security of electronic products, research of anti-counterfeiting technology becomes a matter of great urgency.

### SUMMARY

The foregoing presents a simplified summary of the disclosure in order to provide a basic understanding to the reader. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

The present disclosure provides an image capturing system. The image capturing system includes a main substrate, a laser device, an image sensing device, and a data processing device. The laser device is electrically connected to the main substrate, and the laser device includes a laser source. The laser source is configured to emit a laser light. The image sensing device is electrically connected to the main substrate, and the image sensing device includes an aperture and an image sensor. A reflected light or a scattered light of the laser light passes through the aperture to form an image. The image sensor is configured to generate an image signal according to the image. The data processing device is electrically connected to the main substrate, and configured to generate a liveness detected signal according to the image signal.

In one embodiment, a diameter of the aperture ranges from 0.1 mm to 3 mm.

In one embodiment, when the laser light is emitted on a device under test, the reflected light or the scattered light is formed, wherein a distance between the aperture and the device under test ranges from 0.1 mm to 5 mm.

In one embodiment, a shape of the aperture comprises at least one of circle and polygon.

In one embodiment, a number of the aperture is plural, and shapes of any two apertures of the apertures are the same or different.

In one embodiment, a number of the aperture is plural, and sizes of any two apertures of the apertures are the same or different.

In one embodiment, the data processing device compares the image signal and a liveness threshold, wherein when the image signal conforms the liveness threshold, the data processing device generates the liveness detected signal.

In one embodiment, the image capturing system further includes a database. The database is configured to store the liveness threshold.

In one embodiment, the laser light emitted by the laser source includes a coherence light, wherein when the image, which is formed by the reflected light or the scattered light of the laser light passing through the aperture, includes an interference pattern, the image signal generated by the image sensor according to the image includes an interference signal, wherein the data processing device generates the liveness detected signal according to the image signal which includes the interference signal.

In one embodiment, the interference pattern of the image comprises a speckle.

In one embodiment, the laser device further includes a first conductive layer. The first conductive layer is disposed on the main substrate, and electrically connected to the main substrate, wherein the laser source is disposed on the first conductive layer, and electrically connected to the first conductive layer.

In one embodiment, the image sensing device further includes a second conductive layer. The second conductive layer is disposed on the main substrate, and electrically connected to the main substrate, wherein the image sensor is disposed on the second conductive layer, and electrically connected to the second conductive layer.

In one embodiment, the image sensing device further includes an optical filter. The optical filter is disposed above or below the aperture, and configured to filter an ambient light, wherein the reflected light or the scattered light of the laser light passes through the optical filter.

In one embodiment, the main substrate comprises at least one of a printed circuit board and a flexible printed circuit board.

In one embodiment, the laser source comprises at least one of an edge emitting laser source and a vertical cavity surface emitting laser.

In one embodiment, the laser device further includes a first substrate, a first conductive layer, and a laser source. The first substrate is disposed on the main substrate. The first conductive layer is disposed on the first substrate, and electrically connected to the main substrate. The first conductive layer includes a flat surface and an inclined surface. The laser source is disposed on the flat surface of the first conductive layer, and electrically connected to the first conductive layer. The laser light emitted by the laser source is reflected by the inclined surface. The image sensing device further includes a second conductive layer. The second conductive layer is disposed on the main substrate, and electrically connected to the main substrate. The image sensor is disposed on the second conductive layer, and electrically connected to the second conductive layer.

In one embodiment, an internal angle between the flat surface and the inclined surface ranges from 25° to 75°.

In one embodiment, during a calibration period, the laser device stops emitting the laser light, and the image sensing device continuously senses an ambient light to generate an ambient signal.

In one embodiment, the data processing device calibrates the image signal according to the ambient signal, so as to generate the liveness detected signal.

The present disclosure provides a method for capturing image. The method for capturing image includes steps of: emitting a laser light by a laser source; forming an image by a reflected light or a scattered light of the laser light passing through an aperture of an image sensing device; generating an image signal by an image sensor according to the image; and generating a liveness detected signal by a data processing device according to the image signal.

In one embodiment, a diameter of the aperture ranges from 0.1 mm to 3 mm.

In one embodiment, when the laser light is emitted on a device under test, the reflected light or the scattered light is formed, wherein a distance between the aperture and the device under test ranges from 0.1 mm to 5 mm.

In one embodiment, a shape of the aperture includes at least one of circle and polygon.

In one embodiment, a number of the aperture is plural, and shapes of any two apertures of the apertures are the same or different.

In one embodiment, a number of the aperture is plural, and sizes of any two apertures of the apertures are the same or different.

In one embodiment, the step of generating the liveness detected signal by the data processing device according to the image signal includes comparing the image signal and a liveness threshold by the data processing device; and generating the liveness detected signal by the data processing device when the image signal conforms the liveness threshold.

In one embodiment, the laser light emitted by the laser source includes a coherence light, wherein when the image, which is formed by the reflected light or the scattered light of the laser light passing through the aperture, includes an interference pattern, the image signal generated by the image sensor according to the image includes an interference signal, wherein the data processing device generates the liveness detected signal according to the image signal which includes the interference signal.

In one embodiment, the method for capturing image further includes step of filtering an ambient light by an optical filter, wherein the reflected light or the scattered light of the laser light passes through the optical filter.

In one embodiment, the method for capturing image further includes step of stopping emitting the laser light by the laser device, and continuously sensing an ambient light by the image sensing device to generate an ambient signal during a calibration period.

In one embodiment, step of generating the liveness detected signal by the data processing device according to the image signal includes calibrating the image signal by the data processing device according to the ambient signal, so as to generate the liveness detected signal.

Therefore, based on the technical content of the present disclosure, the present disclosure provides an image capturing system and a method for capturing image to determine whether a device under test is a living body. For example, the image capturing system and the method for capturing image may determine whether a device under test is a human, not a fake prop (e.g., a fabric glue, a rubber fingerprint, and so on) with the biometrics, so as to avoid lawbreakers using fake props to pretend to be users for entering electronic products or account, which affects security of electronic products extremely.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 depicts a schematic diagram of an image capturing system according to one embodiment of the present disclosure;

FIG. 2 depicts a schematic diagram of a circuit block of an image capturing system according to one embodiment of the present disclosure;

FIG. 3 depicts a schematic diagram of a circuit block of an image capturing system according to one embodiment of the present disclosure;

FIG. 4 depicts an operation diagram of part elements of an image capturing system according to one embodiment of the present disclosure;

FIG. 5 depicts an operation diagram of part elements of an image capturing system according to one embodiment of the present disclosure;

FIG. 6 depicts a control timing diagram of an image capturing system according to one embodiment of the present disclosure;

FIG. 7 depicts a control timing diagram of an image capturing system according to one embodiment of the present disclosure;

FIG. 8 depicts a control timing diagram of an image capturing system according to one embodiment of the present disclosure;

FIG. 9 depicts a control timing diagram of an image capturing system according to one embodiment of the present disclosure;

FIG. 10 depicts a control timing diagram of an image capturing system according to one embodiment of the present disclosure;

FIG. 11 depicts a schematic diagram of an image capturing system according to one embodiment of the present disclosure;

FIG. 12 depicts a schematic diagram of an image capturing system according to one embodiment of the present disclosure;

FIG. 13 depicts a schematic diagram of the image sensing device of the image capturing system shown in FIG. 1 according to one embodiment of the present disclosure;

FIG. 14 depicts a schematic diagram of the image sensing device of the image capturing system shown in FIG. 1 according to one embodiment of the present disclosure;

FIG. 15 depicts a schematic diagram of the image sensing device of the image capturing system shown in FIG. 1 according to one embodiment of the present disclosure;

FIG. 16 depicts a schematic diagram of the aperture of the image sensing device of the image capturing system shown in FIG. 1 according to one embodiment of the present disclosure;

FIG. 17 depicts a schematic diagram of the aperture of the image sensing device of the image capturing system shown in FIG. 1 according to one embodiment of the present disclosure;

FIG. 18 depicts a schematic diagram of the aperture of the image sensing device of the image capturing system shown in FIG. 1 according to one embodiment of the present disclosure;

FIG. 19 depicts an operation diagram of the image sensing device of the image capturing system shown in FIG. 1 according to one embodiment of the present disclosure;

FIG. 20A depicts a schematic diagram of a detecting image of a finger of a user according to one embodiment of the present disclosure;

FIG. 20B depicts a schematic diagram of a liveness detection signal of a finger of a user shown in FIG. 20A according to one embodiment of the present disclosure;

FIG. 21A depicts a schematic diagram of a detecting image of a non-living body according to one embodiment of the present disclosure;

FIG. 21B depicts a schematic diagram of a detection signal of the non-living body shown in FIG. 21A according to one embodiment of the present disclosure; and

FIG. 22 depicts a flow diagram of a method for capturing image according to one embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts. However, the embodiments provided herein are intended as illustrative only since numerous modifications and variations therein will be apparent to those skilled in the art. Description of the operation does not intend to limit the operation sequence. Any structures resulting from recombination of elements with equivalent effects are within the scope of the present invention.

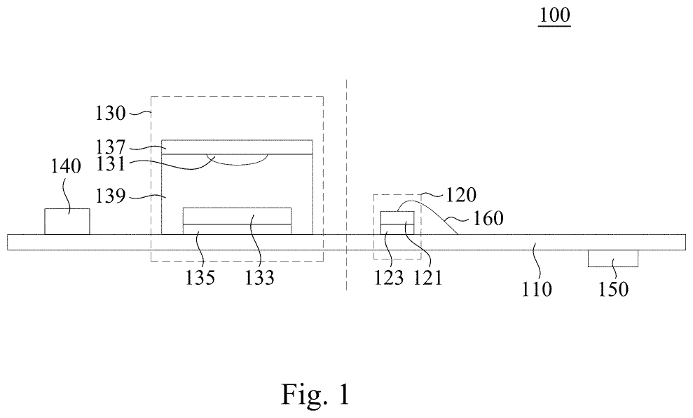

FIG. 1 depicts a schematic diagram of an image capturing system 100 according to one embodiment of the present disclosure. As shown in the figure, the image capturing system 100 includes a main substrate 110, a laser device 120, an image sensing device 130, and a data processing device 140. With respect to the connection, the laser device 120 is electrically connected to the main substrate 110, the image sensing device 130 is electrically connected to the main substrate 110, and the data processing device 140 is also electrically connected to the main substrate 110.

As shown in FIG. 1, the laser device 120 includes a laser source 121. The laser source 121 emits a laser light. The image sensing device 130 includes an aperture 131 and an image sensor 133. When the laser light of the laser source 121 is emitted on a device under test, a reflected light of the laser light is formed. The reflected light of the laser light passes through the aperture 131 to form an image on the image sensor 133. Subsequently, the image sensor 133 generates an image signal according to the image, and the data processing device 140 generates a liveness detected signal according to the image signal. It is noted that, the reflected light shown in the present disclosure is generated by a light emitting on a surface of an object and then the light will be reflected by the object. The reflected light as mentioned in the present disclosure can be a reflected light which is reflected by a surface of an object with uniform reflection angles or can be a scattered light which is reflected by a surface of an object with various reflection angles. For the sake of brevity, the reflected light is used in the figure as an example, but the present disclosure is not intended to be limited thereto. The scattered light can be also used in the present disclosure.

As a result, the image capturing system 100 can be used to determine whether a device under test is a living body. For example, the image capturing system 100 may determine whether a device under test is a human, not a fake prop (e.g., a rubber fingerprint) with the biometrics, so as to avoid lawbreakers using fake props to pretend to be users for entering electronic products or account, which affects security of electronic products extremely.

In one embodiment, the main substrate 110 can be a flexible printed circuit board (Flexible Printed Circuit, FPC). In this embodiment, the flexible printed circuit board can be used to conduct electricity and transmit signal. Therefore, the data processing device 140 can be disposed on the main substrate 110 directly, and the main substrate 110 can be used to conduct electricity and transmit signal. In another embodiment, the image capturing system 100 further includes a connection element 150, and the connection element 150 is used to be connected to external devices. However, the present disclosure is not limited to the above-mentioned embodiments as shown in FIG. 1, and it is merely an example for illustrating one of the implements of the present disclosure. Other suitable elements can be used to implement the main substrate 110 of the present disclosure without departing from the spirit of the present disclosure.

In one embodiment, the laser device 120 further includes a conductive layer 123. The conductive layer 123 is disposed on the main substrate 110, and electrically connected to the main substrate 110. In addition, the laser source 121 is disposed on the conductive layer 123, and electrically connected to the conductive layer 123. In other words, the laser source 121 can be electrically connected to the main substrate 110 through the conductive layer 123. In another embodiment, the laser source 121 can be a distributed feedback (DFB) laser, a distributed Bragg reflector (DBR) laser, a Fabry-Perot laser, a vertical cavity surface emitting laser (VCSEL) or a light-emitting diode. For example, the laser source 121 can be a vertical cavity surface emitting laser (VCSEL). However, the present disclosure is not limited to the above-mentioned embodiments as shown in FIG. 1, and it is merely an example for illustrating one of the implements of the present disclosure. Other suitable elements can be used to implement the laser source 121 of the present disclosure without departing from the spirit of the present disclosure.

In one embodiment, the image capturing system 100 further includes a connection wire 160. As shown in the figure, the laser device 120 can be electrically connected to the main substrate 110 through the connection wire 160.

In one embodiment, the image sensing device 130 further includes a conductive layer 135. The conductive layer 135 is disposed on the main substrate 110, and electrically connected to the main substrate 110. In addition, the image sensor 133 is disposed on the conductive layer 135, and electrically connected to the conductive layer 135. In other words, the image sensor 133 can be electrically connected to the main substrate 110 through the conductive layer 135.

In one embodiment, the image sensing device 130 further includes an optical filter 137. The optical filter 137 is disposed above the aperture 131, and configured to filter the ambient light, such that only the reflected light of the laser light passes through the optical filter 137. As such, the ambient light can be filtered out so as to avoid the ambient light affecting the accuracy of the sensing result of the image sensing device 130, such that a precise liveness detected signal can be obtained. In another embodiment, the image sensing device 130 further includes a package structure 139. In one embodiment, the image sensor 133 can be a complementary metal oxide semiconductor (CMOS) array, a charged coupled device (CDD) array or a photodiode (PD) array. However, the present disclosure is not limited to the above-mentioned embodiments as shown in FIG. 1, and it is merely an example for illustrating one of the implements of the present disclosure. The optical filter 137 can be disposed on other suitable location, or other suitable elements can be used to implement the image sensor 133 of the present disclosure without departing from the spirit of the present disclosure.

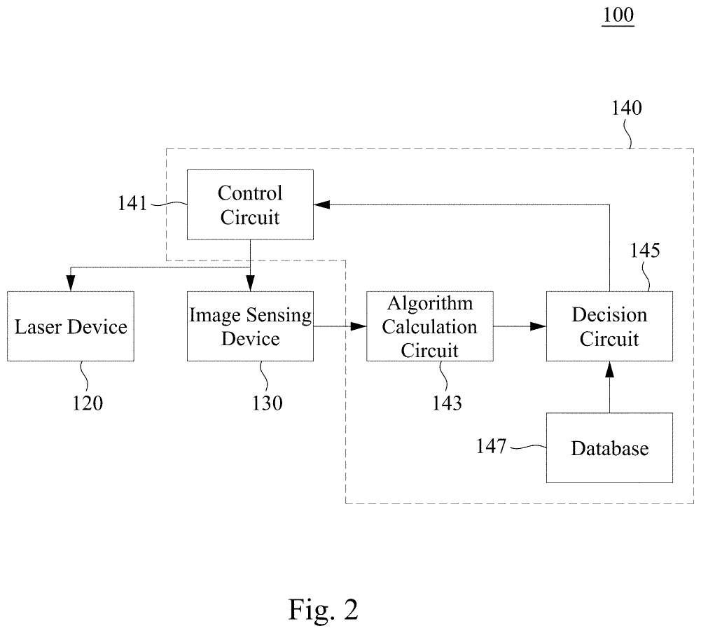

FIG. 2 depicts a schematic diagram of a circuit block of an image capturing system 100 according to one embodiment of the present disclosure. As shown in the figure, the data processing device 140 includes a control circuit 141, an algorithm calculation circuit 143, a decision circuit 145, and a database 147. With respect to the connection, the control circuit 141 and the algorithm calculation circuit 143 are electrically connected to the image sensing device 130. The image sensing device 130 is electrically connected to the laser device 120. In addition, the decision circuit 145 is electrically connected to the control circuit 141, the algorithm calculation circuit 143, and the database 147.

Reference is now made to FIG. 1 and FIG. 2, when the laser light of the laser source 121 of the laser device 120 is emitted on a device under test, the reflected light of the laser light is formed. The reflected light passes through the aperture 131 of the image sensing device 130 to form an image on the image sensor 133 of the image sensing device 130. Subsequently, the image sensor 133 of the image sensing device 130 generates an image signal according to the image.

After that, the image signal is transmitted to the algorithm calculation circuit 143. The algorithm calculation circuit 143 processes the image signal, and transmits the processed image signal to the decision circuit 145. As this time, the decision circuit 145 obtains a liveness threshold stored in the database 147, and compares the image signal with the liveness threshold to find that whether the image signal conforms the liveness threshold. If the image signal conforms the liveness threshold, the data processing device 140 generates a liveness detected signal. For example, the database 147 stores the liveness threshold. Assume that the liveness threshold is set to be 80. If the liveness value corresponding to the image signal is larger than 80, the decision circuit 145 will determine the device under test to be a living body. Subsequently, the data processing device 140 generates the liveness detected signal.

In another embodiment, the threshold range of a living body ranges from 70 to 90. If the liveness value corresponding to the image signal is 85, the decision circuit 145 will determine the liveness value of the image signal is 85 conforms the threshold range of a living body, and the device under test will be determined to be a living body. Subsequently, the data processing device 140 generates the liveness detected signal. In one embodiment, the data processing device 140 can be an application specific integrated circuit (ASIC). It is noted that, the present disclosure is not limited to the above-mentioned embodiments as shown in FIG. 2, and it is merely an example for illustrating one of the implements of the present disclosure. Other suitable values or ranges can be used to implement the liveness threshold or the threshold range of a living body of the present disclosure, or other suitable elements can be used to implement the data processing device 140 of the present disclosure without departing from the spirit of the present disclosure.

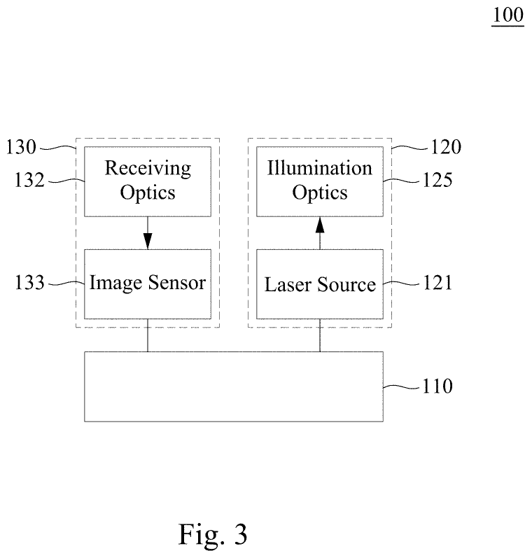

FIG. 3 depicts a schematic diagram of a circuit block of the image capturing system 100 according to one embodiment of the present disclosure. As shown in the figure, the laser device 120 may include illumination optics 125. The illumination optic 125 can be disposed on the laser source 121, and can be used to adjust the laser emitted by the laser source 121. In addition, the image sensing device 130 also includes a receiving optics 132 (e.g., the receiving optics 132 may include the aperture 131, the optical filter 137, and so on), and the receiving optics 132 can be used to perform a primary process to the image. Subsequently, the image sensor 133 performs a secondary process to the image for generating the image signal. However, the present disclosure is not limited to the above-mentioned embodiments as shown in FIG. 3.

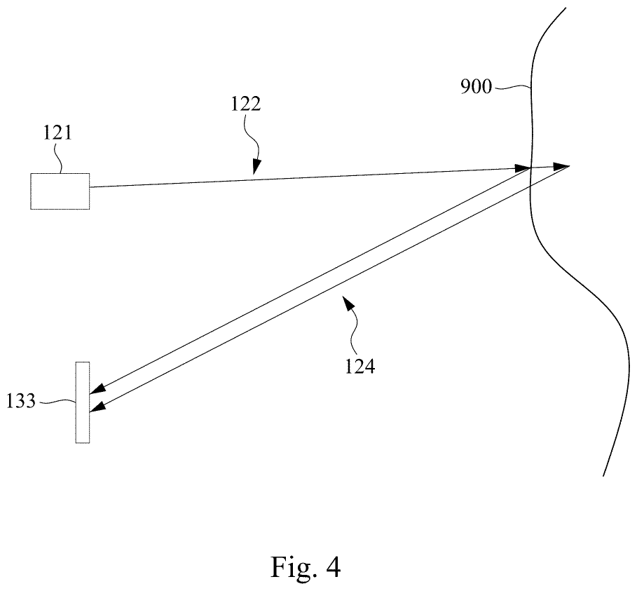

FIG. 4 depicts an operation diagram of part elements of the image capturing system 100 according to one embodiment of the present disclosure. As shown in the figure, the laser light 122 emitted by the laser source 121 can be a coherence light. When the laser light 122 is emitted on the same point of the device under test 900, the reflected light 124 is generated. Take the device under test 900 being a human as an example, when the laser light 122 is emitted on the blood of the living body, an interference effect is generated due to the blood flowing in the living body. This interference effect is similar to the ripple effect which is generated by a water wave hitting a stone. The movement of the water wave will affect another water wave. Similarly, the movement of the blood cells will affect the light, such that the brightness of the reflected light 124 of the living body is different from the brightness of the reflected light 124 of the non-living body.

If the reflected light 124 passes through the aperture 131 shown in FIG. 1, an image having an interference pattern is formed. The image sensor 133 generates an image signal having an interference signal according to the image. The data processing device 140 then generates a liveness detected signal according to the image signal having the interference signal. In another embodiment, the interference pattern of the image is a speckle. However, the present disclosure is not limited to the above-mentioned embodiments as shown in FIG. 4, and it is merely an example for illustrating one of the implements of the present disclosure.

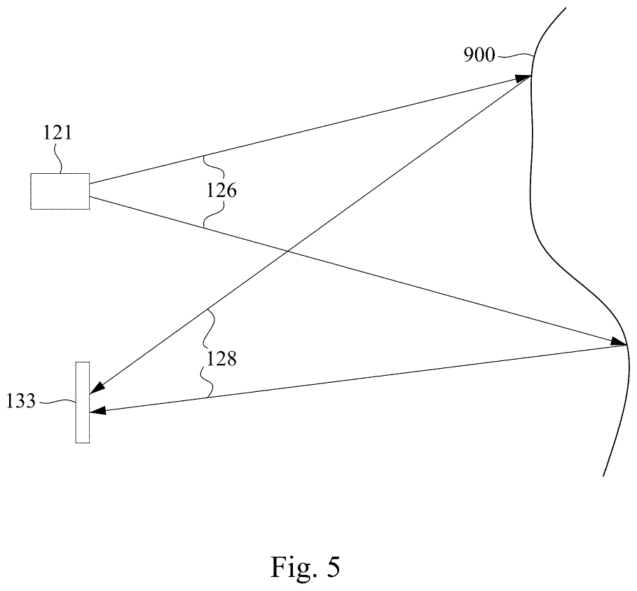

FIG. 5 depicts an operation diagram of part elements of the image capturing system 100 shown in FIG. 1 according to one embodiment of the present disclosure. Compared with FIG. 4, the laser light 126 emitted by the laser source 121 in FIG. 5 will be emitted on different points of the device under test 900, and a reflected light 128 is generated. Similarly, when the laser light 126 is emitted on the living body, an interference effect is generated. If the reflected light 128 passes through the aperture 131 shown in FIG. 1, an image having an interference pattern is formed. The image sensor 133 generates an image signal having an interference signal according to the image. The data processing device 140 then generates a liveness detected signal according to the image signal having the interference signal. However, the present disclosure is not limited to the above-mentioned embodiments as shown in FIG. 5, and it is merely an example for illustrating one of the implements of the present disclosure.

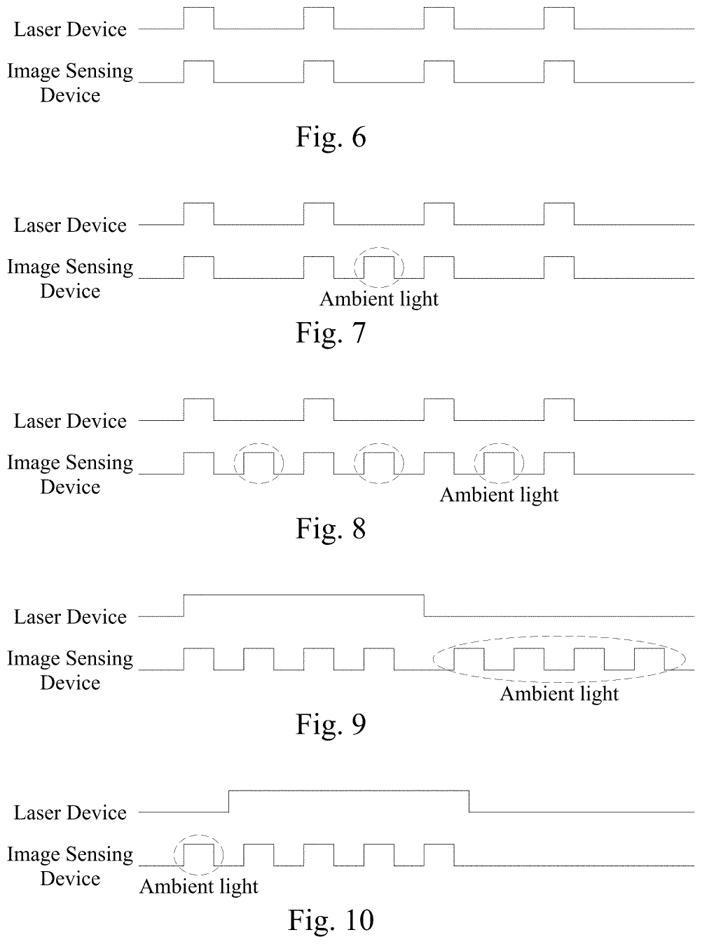

FIG. 6 depicts a control timing diagram of an image capturing system 100 according to one embodiment of the present disclosure. As shown in the figure, when the image capturing system 100 controls the laser device 120 to be turned on and emits a laser light, the image capturing system 100 will also control the image sensing device 130 to be turned on and receives the reflected light of the laser light. However, owing to the effect of the noise (e.g., an ambient light), the image sensing device 130 may receive the noise, such that the accuracy of the sensing result of the image sensing device 130 decreases. Therefore, the present disclosure further provides a manner to solve the above-mentioned problems of the accuracy of the sensing result being affected by the noise, which will be described as shown below.

FIG. 7 depicts a control timing diagram of an image capturing system 100 according to one embodiment of the present disclosure. As shown in the figure, in a calibration period, the image capturing system 100 will control the laser device 120 to stop emitting laser light, and control the image sensing device 130 to continuously sense light. Since the laser device 120 does not emit a laser light, the light that sensed by the image sensing device 130 is an ambient light. The image sensing device 130 will generate an ambient signal according to the ambient light. Subsequently, the data processing device 140 calibrates the image signal according to the ambient signal accurately, so as to generate the liveness detected signal.

In short, during the calibration period, the laser device 120 stops emitting the laser light. At this time, the image sensing device 130 will generate an ambient signal according to the ambient light. The ambient signal can be regard as a noise. The data processing device 140 will filter out the ambient signal, so as to obtain an accurate liveness detected signal.

The following FIG. 8, FIG. 9, and FIG. 10 illustrate different calibration manners. For example, FIG. 8 illustrates that the image sensing device 130 senses multiple ambient lights to be calibrated. FIG. 9 illustrates that the laser device 120 emits the laser light for a long time at first, and stops emitting the laser light for a long time later. The image sensing device 130 senses the laser light periodically, and the image capturing system 100 may obtain accurate ambient light by the above-mentioned manners, so as to calibrate the image signal for generating the liveness detected signal. FIG. 10 illustrates that the laser device 120 emits the laser light for a long time, and the image sensing device 130 senses the laser light periodically. The image capturing system 100 may obtain accurate ambient light by the above-mentioned manners, so as to calibrate the image signal for generating the liveness detected signal. However, the present disclosure is not limited to the above-mentioned embodiments as shown in FIG. 6, to FIG. 10, and it is merely an example for illustrating one of the implements of the present disclosure.

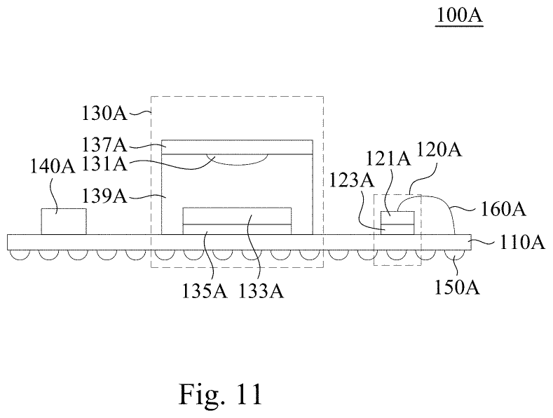

FIG. 11 depicts a schematic diagram of an image capturing system 100A according to one embodiment of the present disclosure. Compared with the image capturing system 100 shown in FIG. 1, the main substrate 110A of the image capturing system 100A in FIG. 11 can be a printed circuit board (PCB), and the symbol which is marked as 150A can be a soldered dot. It is noted that, the element in FIG. 11, whose symbol is similar to the symbol of the element in FIG. 1, has similar structure feature in connection with the element in FIG. 1. Therefore, a detail description regarding the structure feature of the element in FIG. 11 is omitted herein for the sake of brevity. Furthermore, the present disclosure is not limited to the structure as shown in FIG. 11, and it is merely an example for illustrating one of the implements of the present disclosure.

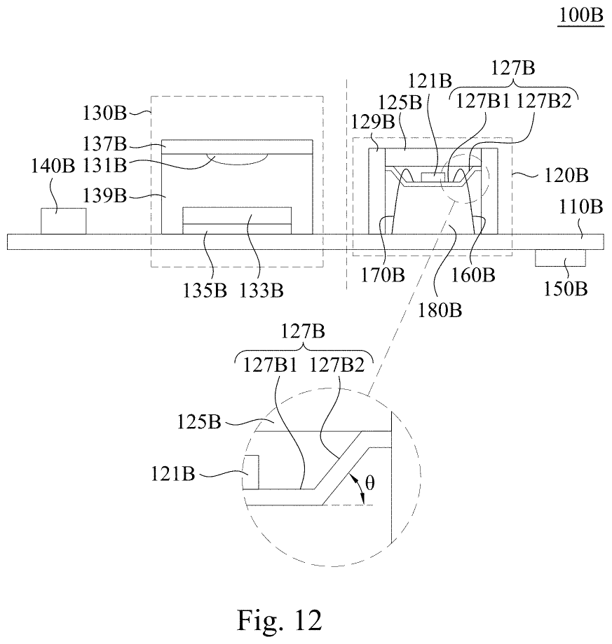

FIG. 12 depicts a schematic diagram of an image capturing system 100B according to one embodiment of the present disclosure. Compared with the image capturing system 100 shown in FIG. 1, the laser device 120B of the image capturing system 100B in FIG. 12 is different, which will be described as shown below.

As shown in the figure, the laser device 120B includes a laser source 121B and a first conductive layer 127B, and a first substrate 180B. The first conductive layer 127B includes a flat surface 127B1 and an inclined surface 127B2. With respect to the structure, the first substrate 180B is disposed on the main substrate 110B. The first conductive layer 127B is disposed on the first substrate 180B, and electrically connected to the main substrate 110B. The laser source 121B is disposed on the flat surface 127B1 of the first conductive layer 127B, and electrically connected to the first conductive layer 127B. With respect to the operation, the laser light emitted by the laser source 121B is reflected by the inclined surface 127B2 of the first conductive layer 127B. In addition, the image sensing device 130B further includes a second conductive layer 135B. The second conductive layer 135B is disposed on the main substrate 110B, and electrically connected to the main substrate 110B. The image sensor 133B is disposed on the second conductive layer 135B, and electrically connected to the second conductive layer 135B.

In one embodiment, an internal angle θ between the flat surface 127B1 and the inclined surface 127B2 ranges from 25° to 75°. In another embodiment, the laser device 120B further includes illumination optics 125B and a package structure 129B. In another embodiment, the laser source 121B can be a distributed feedback (DFB) laser, a distributed bragg reflector, (DBR) laser, a Fabry-Perot laser, a vertical cavity surface emitting laser (VCSEL) or a light-emitting diode. For example, the laser source 121B can be an edge emit laser source.

In one embodiment, the image capturing system 100B further includes connection wires 160B and 170B. As shown in the figure, the laser device 120B is electrically connected to the main substrate 110B through the connection wires 160B and 170B. It is noted that, the element in FIG. 12, whose symbol is similar to the symbol of the element in FIG. 1, has similar structure feature in connection with the element in FIG. 1. Therefore, a detail description regarding the structure feature of the element in FIG. 12 is omitted herein for the sake of brevity. Furthermore, the present disclosure is not limited to the structure as shown in FIG. 12, and it is merely an example for illustrating one of the implements of the present disclosure. Other suitable elements can be used to implement the laser source 121B of the present disclosure without departing from the spirit of the present disclosure.

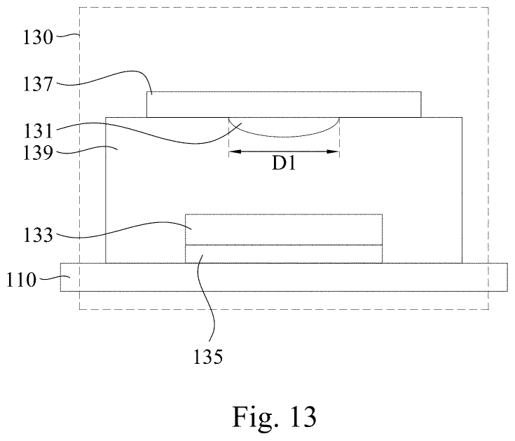

FIG. 13 depicts a schematic diagram of the image sensing device 130 of the image capturing system 100 shown in FIG. 1 according to one embodiment of the present disclosure. As shown in the figure, the aperture 131 of the image sensing device 130 can be a through hole, not an optical lens, such that the light may pass through the aperture 131 directly. In another embodiment, the diameter D1 of the aperture 131 ranges from 0.1 mm to 3 mm. It is noted that, the present disclosure is not limited to the above-mentioned embodiments as shown in FIG. 13, and it is merely an example for illustrating one of the implements of the present disclosure. Other suitable values can be used to implement the diameter of the aperture 131 of the present disclosure without departing from the spirit of the present disclosure.

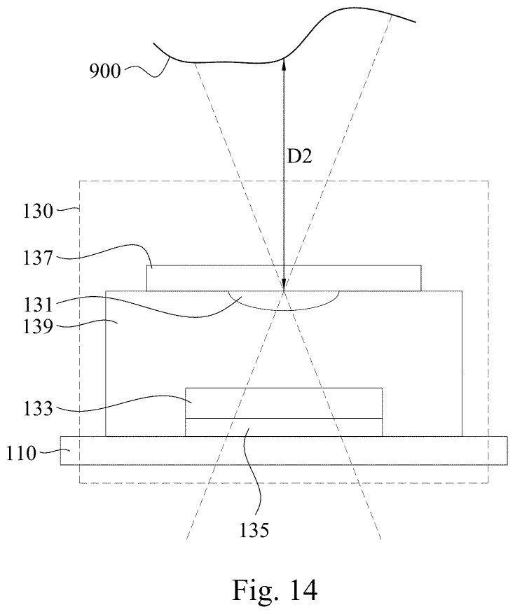

FIG. 14 depicts a schematic diagram of the image sensing device 130 of the image capturing system 100 shown in FIG. 1 according to one embodiment of the present disclosure. As shown in the figure, the distance D2 between the aperture 131 and the device under test 900 ranges from 0.1 mm to 5 mm. It is noted that, the present disclosure is not limited to the above-mentioned embodiments as shown in FIG. 14, and it is merely an example for illustrating one of the implements of the present disclosure. Other suitable values can be used to implement the distance D2 between the aperture 131 and the device under test 900 of the present disclosure without departing from the spirit of the present disclosure.

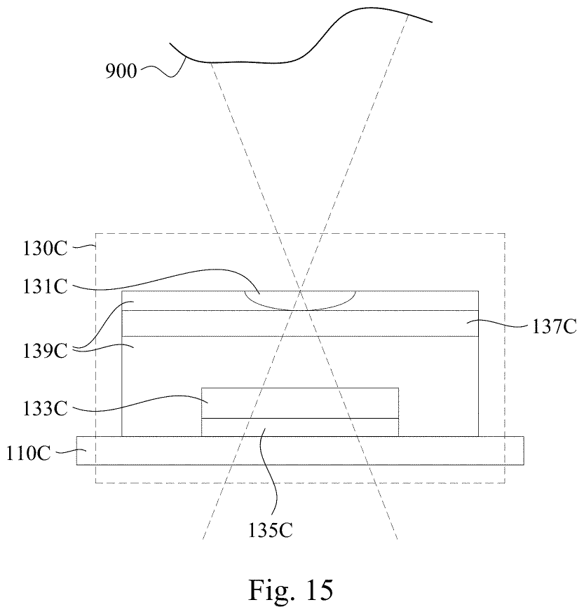

FIG. 15 depicts a schematic diagram of the image sensing device 130C of the image capturing system 100 shown in FIG. 1 according to one embodiment of the present disclosure. Compared with FIG. 1, the optical filter 137C of the image sensing device 130C in FIG. 15 is disposed below the aperture 131C. The optical filter 137C is configured to filter the ambient light, such that the reflected light of the laser light passes through the optical filter 137C. However, the present disclosure is not limited to the above-mentioned embodiments as shown in FIG. 15, and it is merely an example for illustrating one of the implements of the present disclosure. The optical filter 137C can be disposed on other suitable locations of the present disclosure without departing from the spirit of the present disclosure.

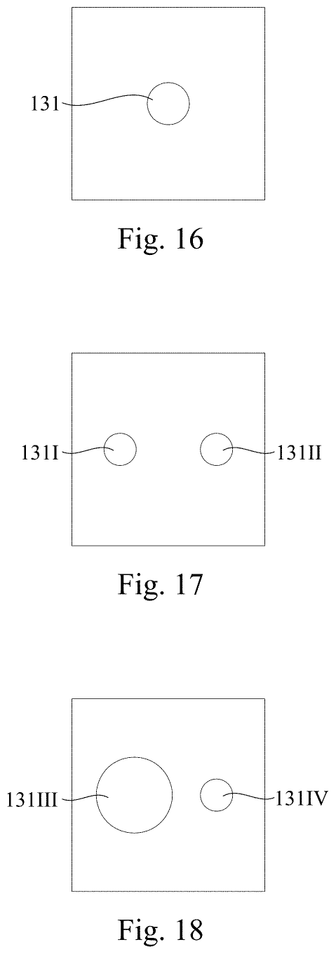

FIG. 16 depicts a schematic diagram of the aperture 131 of the image sensing device 130 of the image capturing system 100 shown in FIG. 1 according to one embodiment of the present disclosure. As shown in the figure, the shape of the aperture 131 can be a circle. However, the disclosure of the present disclosure is not intended to be limited to the shape as shown in FIG. 16, and the shape of the aperture 131 can be a polygon according to the actual requirements.

FIG. 17 depicts a schematic diagram of the aperture 131 of the image sensing device 130 of the image capturing system 100 shown in FIG. 1 according to one embodiment of the present disclosure. As shown in the figure, a number of the aperture can be plural, for example, the first aperture 131I and the second aperture 131II. The shapes of the first aperture 131I and the second aperture 131II can be the same or different.

FIG. 18 depicts a schematic diagram of the aperture 131 of the image sensing device 130 of the image capturing system 100 shown in FIG. 1 according to one embodiment of the present disclosure. As shown in the figure, a number of the aperture can be plural, for example, the first aperture 131III and the second aperture 131IV. The sizes of the first aperture 131III and the second aperture 131IV can be the same or different.

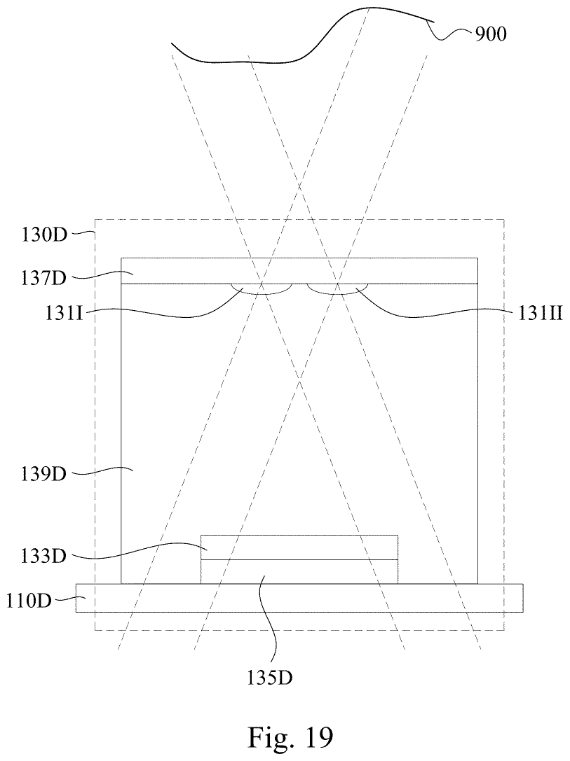

FIG. 19 depicts an operation diagram of the image sensing device of the image capturing system shown in FIG. 1 according to one embodiment of the present disclosure. As shown in the figure, compared with FIG. 1, the number of the apertures of the image sensing device 130D in FIG. 19 can be two. However, the present disclosure is not limited to the above-mentioned embodiments as shown in FIG. 19, and it is merely an example for illustrating one of the implements of the present disclosure. Other suitable number can be used to implement the aperture of the image sensing device 130D of the present disclosure, or the aperture of the image sensing device 130D of the present disclosure can be disposed on other suitable locations without departing from the spirit of the present disclosure.

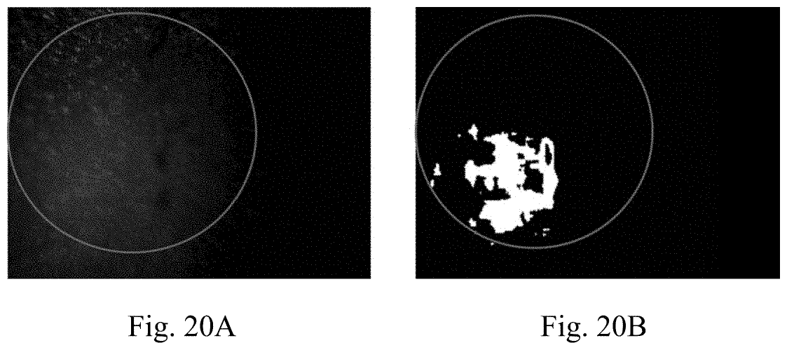

FIG. 20A depicts a schematic diagram of a detecting image of a finger of a user according to one embodiment of the present disclosure. FIG. 20B depicts a schematic diagram of a liveness detection signal of the finger of the user shown in FIG. 20A according to one embodiment of the present disclosure. The photo in FIG. 20A shows that the finger of the user is located on the aperture 131 in FIG. 1. It can be found through experiments that, when the reflected light of the laser light passes through the aperture 131 such that the image sensor 133 generates an interference pattern (e.g., the speckle image marked by the circle in FIG. 20A) according to the image, the speckle image will be blurred due to the interference of the blood flowing. Therefore, when the data processing device 140 in FIG. 1 compares the speckle image signal and a liveness threshold, a liveness detected signal in FIG. 20B is generated.

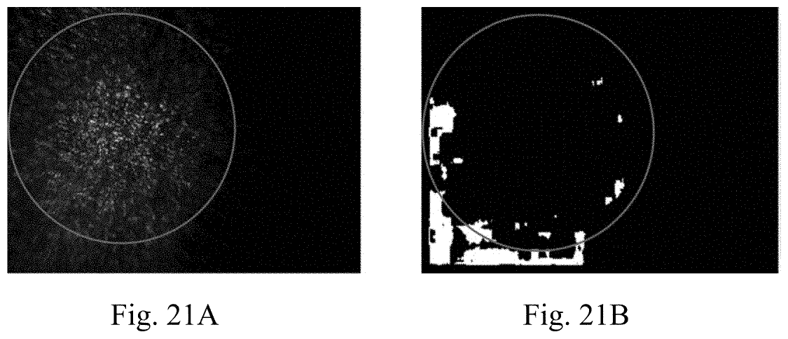

FIG. 21A depicts a schematic diagram of a detecting image of a non-living body according to one embodiment of the present disclosure. FIG. 21B depicts a schematic diagram of a detection signal of the non-living body shown in FIG. 21A according to one embodiment of the present disclosure. The photo in FIG. 21A shows that the finger of a non-living body is located on the aperture 131 in FIG. 1. It can be found through experiments that, when the reflected light of the laser light passes through the aperture 131 such that the image sensor 133 generates an interference pattern (e.g., the speckle image marked by the circle in FIG. 21A) according to the image, the bright contrast of the speckle image is high due to no blood flowing. Therefore, when the data processing device 140 compares the speckle image signal and the liveness threshold, a non-liveness detected signal in FIG. 21B is generated.

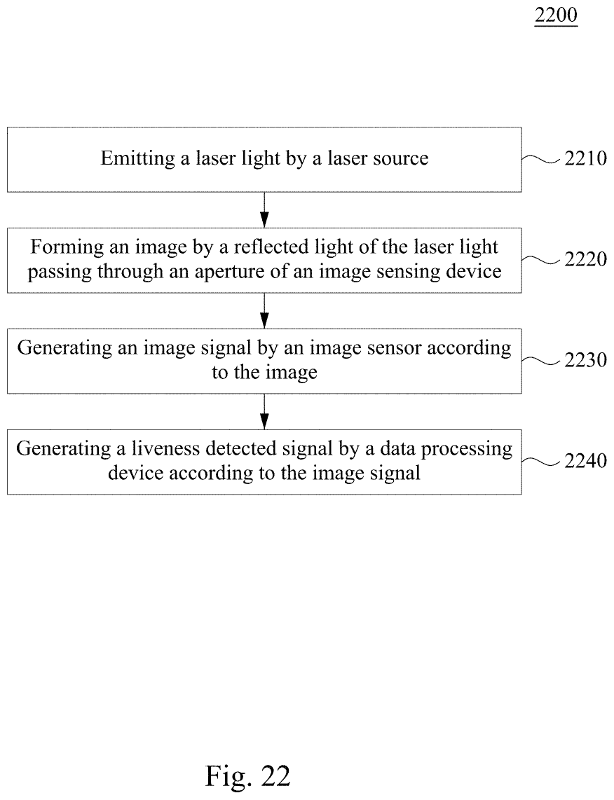

FIG. 22 depicts a flow diagram of a method 2200 for capturing image according to one embodiment of the present disclosure. As shown in the figure, the method 2200 for capturing the image includes the following steps: (step 2210) emitting a laser light by a laser source; (step 2220) forming an image by a reflected light or a scattered light of the laser light passing through an aperture of an image sensing device; (step 2230) generating an image signal by an image sensor according to the image; and (step 2240) generating a liveness detected signal by a data processing device according to the image signal.

For facilitating the understanding of the method 2200 for capturing the image 2200 of the present disclosure, reference is now made to FIG. 1 and FIG. 22. In step 2210, the laser source 121 can be used to emit the laser light. If the laser light of the laser source 121 is emitted on a device under test, the reflected light of the laser light is formed. In step 2220, the reflected light of the laser light passes through the aperture 131 to form the image on the image sensor 133. Subsequently, in step 2230, the image sensor 133 is used to generate the image signal according to the image. In addition, in step 2240, the data processing device 140 is used to generate the liveness detected signal according to the image signal.

In another embodiment, please refer to step 2240. The step of the data processing device 140 being used to generate the liveness detected signal according to the image signal is described in detail as shown below. First of all, the data processing device 140 is used to compare the image signal and the liveness threshold. Secondary, when the image signal conforms the liveness threshold, the data processing device 140 is used to generate the liveness detected signal.

In one embodiment, the laser light 122 emitted by the laser source 121 includes a coherence light. When the image, which is formed by the reflected light of the laser light passing through the aperture 131, includes an interference pattern, the image signal generated by the image sensor 133 according to the image includes an interference signal. The data processing device 140 is used to generate the liveness detected signal according to the image signal which includes the interference signal.

In another embodiment, the method 2200 for capturing the image further includes the step of: filtering an ambient light by the optical filter 137, such that only the reflected light of the laser light passes through the optical filter 137.

In one embodiment, the method 2200 for capturing the image further includes the step of: stopping emitting the laser light by the laser device 120, and continuously sensing the ambient light by the image sensing device 133 to generate the ambient signal during a calibration period.

In another embodiment, please refer to step 2240. The step of generating the liveness detected signal by the data processing device 140 according to the image signal is described in detail as shown below. Since the ambient signal is obtained, the data processing device 140 may calibrate the image signal according to the ambient signal so as to generate the liveness detected signal. It is noted that, the present disclosure is not limited to the steps of the embodiments as shown in FIG. 22, and it is merely an example for illustrating one of the implements of the present disclosure.

It can be understood from the embodiments of the present disclosure that application of the present disclosure has the following advantages. The present disclosure provides an image capturing system and a method for capturing image to determine whether a device under test is a living body. For example, the image capturing system and the method for capturing image may determine whether a device under test is a human, not a fake prop (e.g., a rubber fingerprint) with the biometrics, so as to avoid lawbreakers using fake props to pretend to be users for entering electronic products or account, which affects security of electronic products extremely.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image capturing system, comprising:
a main substrate;
a laser device, electrically connected to the main substrate, comprising:
a laser source, configured to emit a laser light;
an image sensing device, electrically connected to the main substrate, comprising:
an aperture, wherein a reflected light or a scattered light of the laser light passes through the aperture to form an image; and
an image sensor, configured to generate an image signal according to the image; and
a data processing device, electrically connected to the main substrate, and configured to generate a liveness detected signal according to the image signal.

2. The image capturing system of claim 1, wherein a diameter of the aperture ranges from 0.1 mm to 3 mm.

3. The image capturing system of claim 1, wherein when the laser light is emitted on a device under test, the reflected light or the scattered light is formed, wherein a distance between the aperture and the device under test ranges from 0.1 mm to 5 mm.

4. The image capturing system of claim 1, wherein a shape of the aperture comprises at least one of circle and polygon.

5. The image capturing system of claim 1, wherein a number of the aperture is plural, and shapes of any two apertures of the apertures are the same or different.

6. The image capturing system of claim 1, wherein a number of the aperture is plural, and sizes of any two apertures of the apertures are the same or different.

7. The image capturing system of claim 1, wherein the data processing device compares the image signal and a liveness threshold, wherein when the image signal conforms the liveness threshold, the data processing device generates the liveness detected signal.

8. The image capturing system of claim 1, wherein the image capturing system further comprises:
a database, configured to store the liveness threshold.

9. The image capturing system of claim 1, wherein the laser light emitted by the laser source comprises a coherence light, wherein when the image, which is formed by the reflected light or the scattered light of the laser light passing through the aperture, comprises an interference pattern, the image signal generated by the image sensor according to the image comprises an interference signal, wherein the data processing device generates the liveness detected signal according to the image signal which comprises the interference signal.

10. The image capturing system of claim 9, wherein the interference pattern of the image comprises a speckle.

11. The image capturing system of claim 1, wherein the laser device further comprises:
a first conductive layer, disposed on the main substrate, and electrically connected to the main substrate, wherein the laser source is disposed on the first conductive layer, and electrically connected to the first conductive layer.

12. The image capturing system of claim 11, wherein the image sensing device further comprises:
a second conductive layer, disposed on the main substrate, and electrically connected to the main substrate, wherein the image sensor is disposed on the second conductive layer, and electrically connected to the second conductive layer.

13. The image capturing system of claim 1, wherein the image sensing device further comprises:
an optical filter, disposed above or below the aperture, and configured to filter an ambient light, wherein the reflected light or the scattered light of the laser light passes through the optical filter.

14. The image capturing system of claim 1, wherein the main substrate comprises at least one of a printed circuit board and a flexible printed circuit board.

15. The image capturing system of claim 1, wherein the laser source comprises at least one of an edge emitting laser source and a vertical cavity surface emitting laser.

16. The image capturing system of claim 1, wherein the laser device further comprises:
a first substrate, disposed on the main substrate;
a first conductive layer, disposed on the first substrate, and electrically connected to the main substrate, wherein the first conductive layer comprises a flat surface and an inclined surface; and
a laser source, disposed on the flat surface of the first conductive layer, and electrically connected to the first conductive layer, wherein the laser light emitted by the laser source is reflected by the inclined surface;
wherein the image sensing device further comprises:
a second conductive layer, disposed on the main substrate, and electrically connected to the main substrate, wherein the image sensor is disposed on the second conductive layer, and electrically connected to the second conductive layer.

17. The image capturing system of claim 16, wherein an internal angle between the flat surface and the inclined surface ranges from 25° to 75°.

18. The image capturing system of claim 1, wherein during a calibration period, the laser device stops emitting the laser light, and the image sensing device continuously senses an ambient light to generate an ambient signal.

19. The image capturing system of claim 18, wherein the data processing device calibrates the image signal according to the ambient signal, so as to generate the liveness detected signal.

20. A method for capturing image, comprising:
emitting a laser light by a laser source;
forming an image by a reflected light or a scattered light of the laser light passing through an aperture of an image sensing device;
generating an image signal by an image sensor according to the image; and
generating a liveness detected signal by a data processing device according to the image signal.

21. The method for capturing image of claim 20, wherein a diameter of the aperture ranges from 0.1 mm to 3 mm.

22. The method for capturing image of claim 20, wherein when the laser light is emitted on a device under test, the reflected light or the scattered light is formed, wherein a distance between the aperture and the device under test ranges from 0.1 mm to 5 mm.

23. The method for capturing image of claim 20, wherein a shape of the aperture comprises at least one of circle and polygon.

24. The method for capturing image of claim 20, wherein a number of the aperture is plural, and shapes of any two apertures of the apertures are the same or different.

25. The method for capturing image of claim 20, wherein a number of the aperture is plural, and sizes of any two apertures of the apertures are the same or different.

26. The method for capturing image of claim 20, wherein generating the liveness detected signal by the data processing device according to the image signal comprises:
comparing the image signal and a liveness threshold by the data processing device; and
generating the liveness detected signal by the data processing device when the image signal conforms the liveness threshold.

27. The method for capturing image of claim 20, wherein the laser light emitted by the laser source comprises a coherence light, wherein when the image, which is formed by the reflected light or the scattered light of the laser light passing through the aperture, comprises an interference pattern, the image signal generated by the image sensor according to the image comprises an interference signal, wherein the data processing device generates the liveness detected signal according to the image signal which comprises the interference signal.

28. The method for capturing image of claim 20, further comprising:
filtering an ambient light by an optical filter, wherein the reflected light or the scattered light of the laser light passes through the optical filter.

29. The method for capturing image of claim 20, further comprising:
stopping emitting the laser light by the laser device, and continuously sensing an ambient light by the image sensing device to generate an ambient signal during a calibration period.

30. The method for capturing image of claim 29, wherein generating the liveness detected signal by the data processing device according to the image signal comprises:
calibrating the image signal by the data processing device according to the ambient signal, so as to generate the liveness detected signal.
